(19) United States
(12) Patent Application Publication
(10) Pub. No.: US 2006/0055557 A1
(43) Pub. Date: Mar. 16, 2006

(54) Traffic light prediction system

(76) Inventor: Guixian Lu, Pontiac, MI (US)

Correspondence Address: Guixian Lu, 853 Melrose Road, Pontiac, MI, 48340, US

(21) Appl. No.: 10/894,922

(22) Filed: Jul. 20, 2004

(51) Int. Cl. G08G 1/095; G08G 1/123

(52) U.S. Cl. 340/907; 340/994

(57) ABSTRACT

The present invention is a system to predict colors of a traffic light before vehicles reach the traffic light, helping the drivers to avoid stopping at red light. There are three kinds of moving zones: green, yellow, and red defined on the street before a traffic light. The moving zones may be indicated by red, yellow, and green elements (small lights). The moving zones are moving towards the traffic light. Around the time a green zone reaches the traffic light, the traffic light changes from red to green.

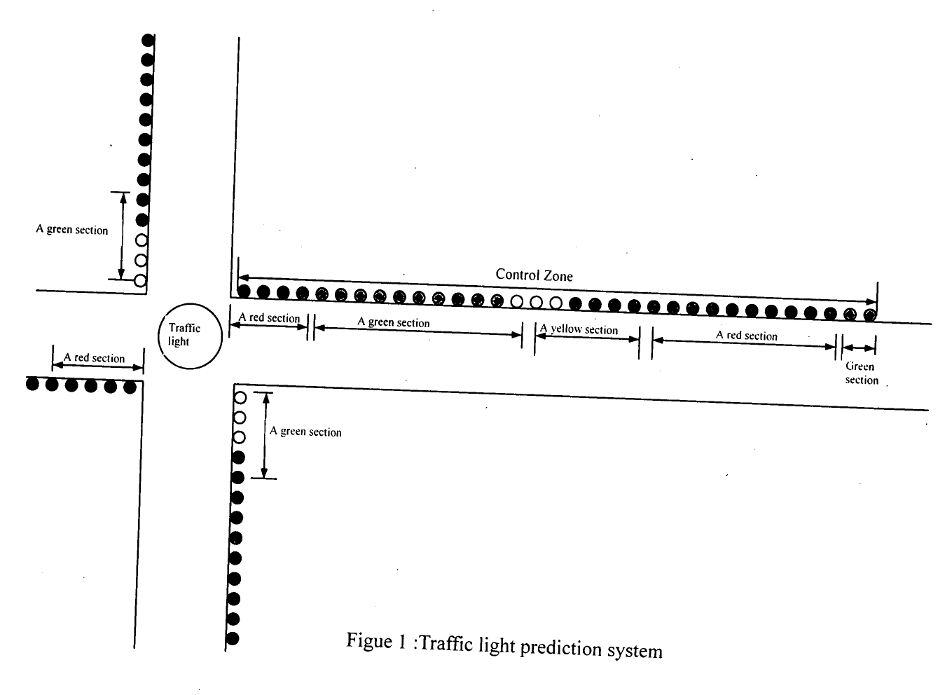

### BACKGROUND OF THE INVENTION

1. Field of the Invention

The present invention relates to a prediction system to predict colors of traffic lights.

2. Prior Art

There are many traffic lights in a city. When a vehicle run into a red light, it must stop and wait until the light change to green before it can go.

That wastes energy on fuel and makes more pollution. That is why the hybrid vehicles are hot now.

### SUMMARY OF THE INVENTION

The principle object of the present invention is to save fuel energy for vehicles. It is another object to reduce pollution from vehicles. It is also an object of the present invention to save traffic time.

The foregoing objects are accomplished by defining color zones on a street. Usually each kind of zone represents one color on the traffic light. There are some indicators to let drivers know the position and color of each zone so that the drivers can change from one zone to another in order to avoid stopping at a red light.

### BRIEF DESCRIPTION OF THE DRAWING

On the right of the traffic light, it can be seen a Controlled Area, covered by the zones. The color of each light can be changed to red, green, or yellow. There are two red zones, two green zones and a yellow zone in the Controlled Area. The position and color of each zone are indicated by indicators (lights) on one side of the street. The first zone from the left of the Controlled Area is the closest zone to the traffic light and is a red zone, which is not a full length, meaning the light has been for some time. The second zone is green and full. The third one is yellow and full. The fourth zone is red and full. The fifth one is green. The fifth one is not full because it just started to grow from zero length. All the zones in the Controlled Area are moving from right to left towards the traffic light.

### DETAILED DESCRIPTION

The present invention defines three kinds of zone on streets before a traffic light: red, green, and yellow, representing three colors of the traffic light. There is a Controlled Area along the length of the street where the moving zones move. The Controlled Area is ending at the traffic light and beginning somewhere on the street. Every moving zone starts from the far end of the Controlled Area and ends at the traffic light. The length of the Controlled Area (total length of moving zones) is long enough to let the drivers to move their vehicles from one zone to another before they reach the traffic light. All moving zones are moving towards the traffic light. Usually the speed of a moving zone is the same as the speed limit on the street. The full length of each moving zone is approximately equal to the speed multiplied by the length of time (period) of the color that the zone represents. Let say the speed is 30 mile per hour. The length of green color on the traffic light is 0.5 minute. The full length of a green zone should be 0.25 mile. Usually the length of each full zone is a constant. When a green zone reaches the traffic light, it is about the time that the traffic light changes from red to green. Then the length of the green zone decreases from full length to zero as the following zone (yellow) coming towards the light. The zone that is closest to the traffic light always has the same color as the traffic light. A driver knows the traffic light he or she will catch is the same color of the zone he or she is at. The vehicle should move within a green zone in order to catch a green light.

There are indicators to show the drivers about the position and color of each zone. The indicators may be small lights. The lights at both ends of each zone keep changing their color so that it looks like that the zone is moving. There is a control sub-system to control the length and movement of the zones. The control sub-system is synchronized with the traffic light so that every zone that is close to the traffic light has the same color as the traffic light.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description but rather by the claims appended hereto.

What is claim is:

1. A Traffic Light Prediction System consists of at least two kinds of moving zone, indicators, and a control sub-system to help the drivers to avoid stopping at a red light.

2. A Traffic Light Prediction System of claim 1 wherein said each kind of moving zone represents at least one color(s) of the traffic light. The full length of each moving zone of each kind is approximately equal to speed of said zone multiplied by the time length (period) of the color(s) that said kind represents. Said zones are moving towards the traffic light.

3. A Traffic Light Prediction System of claim 1 wherein said indicators indicate the position and color of said moving zones.

4. A Traffic Light Prediction System of claim 1 wherein said control sub-system controls the length and movement of said zones and is synchronized with the traffic light. The color of a closest zone to the traffic light has the same color with the traffic light for most of the time. Around the time that said each zone reaches the traffic light, the traffic light changes to the color of said zone represents.
